(19) United States
(12) Patent Application Publication
(10) Pub. No.: US 2026/0267005 A1
(43) Pub. Date: Sep. 10, 2026

(54) Electronic device for detecting GNSS interference, associated vehicle, method and computer program

(71) Applicant: THALES, Meudon (FR)

(72) Inventors: Sébastien François Philippe LEGOLL, VALENCE (FR); Jacques COATANTIEC, VALENCE (FR); Nicolas Jean-Marc Frédéric VERCIER, VALENCE (FR)

(21) Appl. No.: 19/167,098

(22) PCT Filed: Mar. 22, 2024
(86) PCT No.: PCT/EP2024/057742

§ 371 Date: Sep. 19, 2025

(30) Foreign Application Priority Data
Mar. 22, 2023 (FR) FR2302680

(51) Int. Cl. G01S 19/21; G01S 19/39; G01S 19/47

(52) U.S. Cl. CPC G01S 19/21; G01S 19/393; G01S 19/47

(57) ABSTRACT

A device for detecting GNSS interference(s), including at least an inertial measurement unit, a GNSS receiver, a Kalman filter configured to cyclically calculate an innovation vector by hybridization of data provided by the inertial measurement unit and the GNSS receiver, and additionally, at the output of the Kalman filter, a filtering module applying at least one filtering on each component of the innovation vector provided at each calculation cycle, and an interference detection module, detecting interference when, during Q cycles and on a number U of components of the innovation vector, the absolute value of the output of the filtering module, for at least one filtering, is greater than a predetermined threshold.

### CROSS-REFERENCE TO RELATED APPLICATIONS

This application claims benefit under 35 USC § 371 of PCT Application No. PCT/EP2024/057742 entitled ELECTRONIC DEVICE FOR DETECTING GNSS INTERFERENCE, ASSOCIATED VEHICLE, METHOD AND COMPUTER PROGRAM, filed on Mar. 22, 2024 by inventors Sébastien François Philippe Legoll, Jacques Coatantiec and Nicolas Jean-Marc Frédéric Vercier. PCT Application No. PCT/EP2024/075542 claims priority of French Patent Application No. 23 02680, filed on Mar. 22, 2023.

### FIELD OF THE INVENTION

The present invention relates to an electronic device for detecting GNSS interference suitable for being embedded on a vehicle suitable for moving between two geographical positions, the device comprising at least: an inertial measurement unit suitable for providing navigation measurements, a GNSS receiver for satellite positioning measurements, a Kalman filter configured to cyclically calculate an innovation vector by hybridization of data provided, as input to said Kalman filter, both by said inertial measurement unit and by said GNSS receiver.

The invention also relates to a vehicle comprising such an electronic device for detecting GNSS interference.

The invention also relates to a method for detecting GNSS interference, said method being implemented by an electronic device for detecting GNSS interference suitable for being embedded on a vehicle suitable for moving between two geographical positions.

The invention also relates to a computer program including software instructions, which, when executed by a computer, implement such a method for detecting GNSS interference.

### BACKGROUND OF THE INVENTION

The present invention relates to the navigation of a vehicle (also called a carrier) suitable for moving between two distinct geographical positions, such as a land vehicle corresponding specifically to a car, a truck, or such as an aircraft or any type of carrier.

To do this, the vehicle generally comprises a satellite navigation and positioning system receiver configured to determine, specifically by trilateration, a positioning (i.e. a geolocation position or a geolocation solution) of the vehicle using distance estimates to visible satellites from one or more satellite constellations of the satellite navigation and positioning system. Examples of satellite navigation systems include the American GPS system (from the English “Global Positioning System”), the European GALILEO system, the Russian GLONASS system, or the Chinese BEIDOU system, etc.

More precisely, the present invention focuses on the detection of interferences, called “GNSS interferences”, from the hybridization between the inertial data and the data received by the GNSS receiver, also referred to hereafter as inertial/GNSS hybridization.

Hereafter, “GNSS interference” means interference consisting of sending erroneous radio frequency signals to the GNSS receiver. The GNSS receiver then uses these erroneous signals to calculate the navigation data of the vehicle wherein it is embedded, such as its position and speed, which will then be different from the exact (i.e. “true”) data, due to errors on the radio frequency signals.

For example, such GNSS interference occurs when inside hangars located at airports, GNSS signal repeaters, specifically GPS, are used to propagate these signals inside hangars, so as to be used to assist an aircraft pilot located inside the hangars to position themselves.

However, when the doors of these hangars are open, the signals from these repeaters are likely to propagate outside the hangars and be captured by aircraft located outside, which must use the direct GNSS signals to position themselves, and not the signals from these repeaters, which then constitute interference for aircraft outside the hangars.

To remedy this, a current technique for detecting such GNSS interference is described in the DO-229D standard “Minimum Operational Performance Standards for Global Positioning System/Satellite-Based Augmentation System Airborne Equipment” and. in particular, in appendix R 3 1 1, and consists of using the hybridization between inertial data and the GPS data to detect interference using a Kalman filter.

More precisely, this current technique first calculates the innovation vector, during hybridization, which constitutes the difference between the measured gap between GNSS data and the inertial data, on the one hand, and, on the other, the predicted gap in this data according to the hybridization model.

Then, this technique implements a comparison of the different components of this innovation vector to the expected standard deviation on each component of the innovation vector, this expected standard deviation being calculated from the covariance matrix P of the Kalman filter used for the calculation of the innovation vector, and, when the absolute value of one or more components of the innovation vector is much greater than the expected standard deviation, deactivates the use of the GNSS receiver data because there is potentially a problem with the GNSS data, coming from interference or another phenomenon.

This current technique is unsatisfactory, however, because interference on the GNSS data can cause an error that gradually increases over time without causing too significant changes in the value of the components of the innovation vector, at each calculation cycle of the Kalman filter, so that the values of the components of this innovation vector will be of the same order of magnitude as those present in the absence of interference, and will not be much greater than the standard deviation calculated from the covariance matrix P of the Kalman filter used in the calculation of the innovation vector. Thus, such interference on GNSS data will not be detected most of the time, or at least not immediately, or quickly, after the appearance of such interference.

Another technique is also described in the document “Fault Detection, Integrity Monitoring, and Testing” by Groves Paul D, which focuses on the integrity control of navigation systems; however, this technique is not optimal in terms of filtering.

### SUMMARY OF THE DESCRIPTION

The aim of the invention is then to propose an electronic device for detecting GNSS interference(s) that overcomes the disadvantages of the current technique by increasing the efficiency and reactivity of GNSS interference detection.

To this end, the invention relates to an electronic device for detecting GNSS interference(s), suitable for being embedded on a vehicle suitable for moving between two geographical positions, the device comprising at least:
an inertial measurement unit suitable for providing navigation measurements,
a GNSS receiver for satellite positioning measurements,
a Kalman filter configured to cyclically calculate an innovation vector by hybridization of data provided, as input to said Kalman filter, both by:
said inertial measurement unit, and
said GNSS receiver,
the device further comprising, at the output of said Kalman filter:
a filtering module configured to apply at least one filtering on each component of the innovation vector provided at each calculation cycle by said Kalman filter,
an interference detection module configured to detect interference when, for Q cycles and on a number U of components of the innovation vector, with Q and U each being an integer greater than or equal to one, the absolute value of the output of the filtering module, for at least one filtering applied by said module, is greater than a predetermined threshold.

Moreover, the filtering module is configured to apply at least one filtering with predetermined filtering coefficients, using a finite impulse response filter, whose N filtering coefficients, for each component of the innovation vector, are calculated with said predetermined filtering coefficients, said filtering coefficients being predetermined for each interference type from a set of predetermined interferences types and, for each type of navigation phase, from a set of predetermined types of navigation phases associated with said vehicle.

Thus, the electronic device for detecting GNSS interference(s) according to the present invention has a particular architecture allowing the detection of interferences by using not directly the components of the innovation vector but the output of a filtering on these components.

In other words, the present invention consists of using an electronic device for detecting GNSS interference(s) suitable for applying a single or multiple filtering on each component of the innovation vector, and for using the output of this filtering to detect the GNSS interferences.

Indeed, the present invention aims to exploit the fact that the evolution over time the of the innovation vector components differs, depending on whether interference is present at the GNSS data level or not. The filtering used specifically according to the present invention then allows for highlighting this difference in evolution over time, at the level of the output returned by the filtering.

Moreover, advantageously, for each considered navigation phase and each considered interference type, the method of calculating the predetermined filtering coefficients is optimized, in order to obtain a minimum probability of non-detection, as hereafter, with the predetermined filtering coefficients being suitable for differing, according to the interference type and/or according to the type of navigation phase.

According to other advantageous aspects of the invention, said predetermined threshold depends on the filtering type applied by the filtering module and/or the current calculation cycle.

The invention also relates to a vehicle comprising such an electronic device for detecting GNSS interference(s).

The invention also relates to a method for detecting GNSS interference(s), said method being implemented by an electronic device for detecting GNSS interference(s) suitable for being embedded on a vehicle suitable for moving between two geographical positions, the method comprising at least the following steps:
cyclic calculation of an innovation vector, implemented by a Kalman filter of said device, by hybridization of data provided, as input to said Kalman filter, both by an inertial measurement unit suitable for providing navigation measurements and by a GNSS receiver for satellite positioning measurements;
application of at least one filtering on each component of the innovation vector provided at each calculation cycle by said Kalman filter, with predetermined filtering coefficients, using a finite impulse response filter, whose N filtering coefficients, for each component of the innovation vector, are calculated with said predetermined filtering coefficients, said filtering coefficients being predetermined for each type of interference from a set of predetermined interference types and for each type of navigation phase from a set of predetermined types of navigation phases associated with said vehicle;
detection of interference when, for Q cycles and on a number U of components of the innovation vector, with Q and U each being an integer greater than or equal to one, the absolute value of the filtering output, for at least one filtering, is greater than a predetermined threshold.

The invention also relates to a computer program comprising software instructions which, when executed by a computer, implement such a method for detecting GNSS interference(s) as defined above.

### BRIEF DESCRIPTION OF THE DRAWINGS

These features and advantages of the invention will become clearer upon reading the following description, given solely by way of non-limiting example and made with reference to the appended drawings, wherein:

FIG. 1 is a diagram illustrating an electronic device for detecting GNSS interference(s);

FIG. 2 is a flowchart representing the method for detecting GNSS interference(s) according to the present invention;

FIG. 3 illustrates the kth normalized component of the innovation vector under the effect of interference as well as the weighted sum of this normalized component obtained at the output of the filtering implemented according to an embodiment of the invention;

FIGS. 4 and 5 illustrate the predetermined filtering coefficients, the kth normalized component of the innovation vector as well as the filtering output, with said predetermined filtering coefficients implemented according to another embodiment of the invention and under the effect of interference occurring from distinct calculation cycles.

### DETAILED DESCRIPTION OF EMBODIMENTS

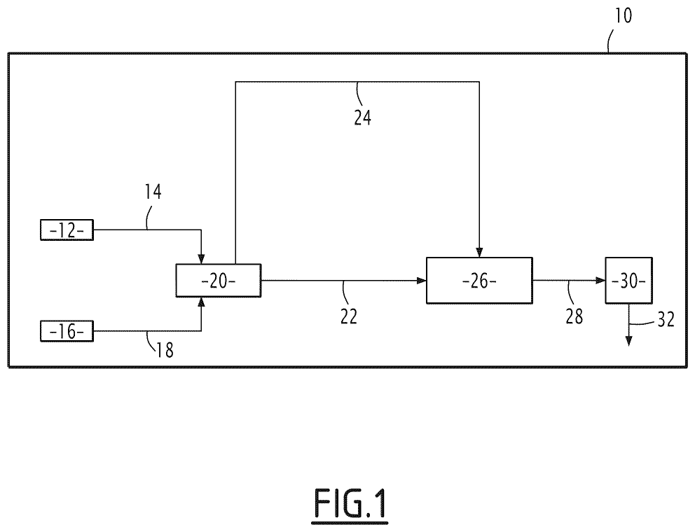

FIG. 1 is an overall representation of an electronic device 10 for detecting GNSS interference(s) according to the present invention.

Such an electronic device 10 for detecting GNSS interference(s) is suitable for being embedded on a vehicle suitable for moving between two geographical positions.

As illustrated by FIG. 1, such a device 10 first comprises an inertial measurement unit 12 suitable for providing navigation measurements 14.

Moreover, such a device 10 comprises a GNSS receiver 16 for satellite positioning measurements 18.

Such a device 10 also comprises a Kalman filter 20 configured to cyclically calculate an innovation vector 22 by hybridization of data provided, as input to said Kalman filter, both by said inertial measurement unit 12 and by said GNSS receiver 16.

In other words, the electronic device 10 for detecting GNSS interference(s) is first configured to use the inertial data (i.e. the navigation measurements 14) and the GNSS receiver data (i.e. the satellite positioning measurements 18) by performing a hybridization between these data, thanks to a Kalman filter activated at different calculation cycles, these calculation cycles representing the elapsed time.

Thus, the hybridization implemented by the Kalman filter 20 consists of mathematically combining the measurements 14 and 18 provided by the inertial measurement unit 12 and the GNSS satellite positioning measurements receiver 16 of said vehicle, respectively, to obtain position and speed information by taking advantage of these two sources 12 and 16 of measurements 14 and 18, respectively.

The Kalman filtering relies on the possibilities of modeling the evolution of the state of a physical system considered in its environment, by means of an “evolution” equation (estimation a priori), and modeling the dependency relationship existing between the states of the physical system considered and the measurements of an external sensor, by means of an “observation” equation to allow for recalibration of the filter states (estimation a posteriori). In a Kalman filter, the effective measurement or “measurement vector” allows for an a posteriori estimate of the system state that is optimal in the sense that it minimizes the covariance of the error made on this estimate. The estimator part of the filter generates a posteriori estimates of the system state vector using the observed discrepancy between the effective measurement vector and its prediction a priori to generate a corrective term, called innovation. This innovation, called innovation vector hereafter, after multiplication by a Kalman filter gain matrix, is, in a non-represented manner, suitable for being applied to the a priori estimate of the system state vector and leads to obtaining the optimal a posteriori estimate.

The Kalman filtering implemented by the Kalman filter 20 is thus also suitable for modeling the evolution of errors of the inertial measurement unit 12 and for delivering, in a non-represented manner, the a posteriori estimate of these errors which serves to correct the positioning and speed point of the inertial measurement unit 12.

More precisely, at each calculation cycle n, the observation vector Zₙ is calculated, which constitutes the gap between the inertial data 14 (i.e. the navigation measurements 14) and the GNSS data 18 (i.e. the satellite positioning measurements 18).

Such an observation vector Zₙ, according to a first example, corresponds to the gap between the inertial position associated with the inertial data 14 and the GNSS position associated with the GNSS data 18, or, according to another example, to the gap between the pseudo-range associated with the satellite positioning measurements 18 corresponding to the distance between the GNSS receiver of the carrier and the satellites emitting radio frequency signals, and the pseudo-range calculated from the inertial position of the carrier and the position of the satellites emitting radio frequency signals.

The classic operation of the Kalman filter in the field of the invention is related below.

The Kalman filter 20 is first configured to define the state vector Xₙ, with NE components, which gathers a certain number of unknown states that one wishes to estimate, with one component of the vector Xₙ being the error in the inertial position for example.

Then, the Kalman filter 20 is configured to write the relationship between the observation vector Zₙ, with N_{O} components, with this vector being known, and the state vector Xₙ to be estimated in the form Zₙ=Hₙ*Xₙ+vₙ, with Hₙ the known observation matrix, vₙ the unknown measurement noise, considered as Gaussian noise, but whose variance Rₙ is known.

Then, the Kalman filter 20 is configured to calculate the vector Xₙⱼₙ₋₁ corresponding to the estimation of the vector Xₙ from the observations Z₁, Z₂, . . . . Zₙ₋₁, then to calculate the innovation vector Yₙ=Zₙ−Hₙ*Xₙⱼₙ₋₁.

This innovation vector Yₙ itself is thus the gap between Zₙ, corresponding to the gap obtained between the inertial data 14 and the GNSS data at cycle n, on the one hand, and, on the other, Hₙ*Xₙⱼₙ₋₁, corresponding to the predicted gap from the estimation Xₙⱼₙ₋₁. In other words, Yₙ corresponds to the predicted gap from the hybridization model.

The Kalman filter 20 is also suitable for generating the elements 24 σₙ(k), with k varying between 1 and N_{O} (N_{O} being the number of components of the innovation vector Yₙ), each element σₙ(k) corresponding to the expected standard deviation, in the absence of interference, for the k component of the innovation vector Yₙ, the calculation of σₙ(k) calling on Rₙ the variance of the measurement noise vₙ.

It should be noted that it can be demonstrated that, in the absence of interference, for each value of k between 1 and N_{O} (with N_{O} being the dimension of the innovation vector), Yₙ(k), when n varies, corresponds to Gaussian white noise with a standard deviation σₙ(k). It should also be noted that it can be demonstrated that, under the effect of interference, for each value of k between 1 and N_{O}, the k^{th} component of the innovation vector, when n varies, can be expressed as a sum of the effect due solely to the interference on the one hand and the Gaussian white noise with a standard deviation σₙ(k) calculated by the Kalman filter 20.

Specifically, according to the present invention, as illustrated by FIG. 1, the electronic device 10 for detecting GNSS interference(s) further comprises a filtering module 26 at the output of said Kalman filter 20, configured to apply at least one filtering on each component k of the innovation vector Yₙ 22 provided at each calculation cycle by said Kalman filter 20.

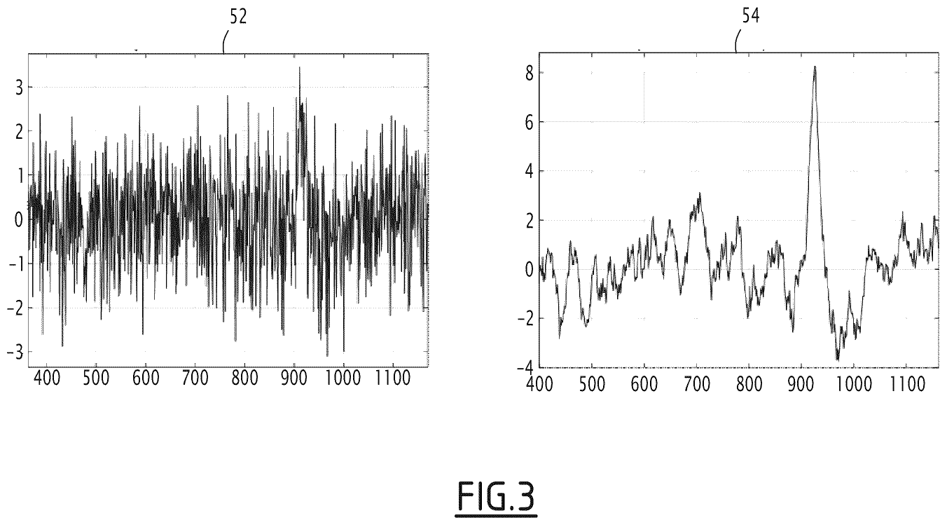

Indeed, as described hereafter in relation to FIGS. 3 to 5, such a filtering module aims to use the fact that, at the beginning of the application of the interference, the normalized components of the innovation vector Yₙ(k)/sₙ(k) have a behavior that does not correspond to what they have in the absence of interference.

More precisely, the filtering module 26 is configured to apply a single or multiple filtering, via one or more filters respectively, at each calculation cycle n of the Kalman filter 20, on each component of the innovation vector.

The output of the filter of index J or a filter of index J of the filters of the filtering module 26 is noted: Sun (k).

In the case where the filter of index J (also called filter J hereafter) corresponds to a finite impulse response filter, which corresponds to the fact that the output of this filter J at a given time depends only on the last N values of the filter input, one can write Sin (k) as follows:

$${S}_{n}^{J} ( k ) = {\sum }_{i = 0}^{N - 1} {a}_{i , n}^{J} ( k ) {Y}_{n - i} ( k ) ,$$

which comes down to:

$${S}_{n}^{J} ( k ) = {a}_{0 , n}^{J} ( k ) * {Y}_{n} ( k ) + {a}_{1 , n}^{J} ( k ) * {Y}_{n - 1} ( k ) + … + {a}_{N - 1 , n}^{J} ( k ) * {Y}_{n - ( N - 1 )} ( k ) ,$$

with Yₙ(k), the kth component of the innovation vector calculated at the current cycle n, Yₙ₋₁(k) is the kth component of the innovation vector calculated at the previous cycle n−1, and a^{J}_{0,n}(k), a^{J}_{1,n}(k), . . . , a^{J}_{N-1,n}(k) the coefficients of the filter J, which potentially depend on said filter J considered, the kth component of the innovation vector considered, and the current cycle n.

Moreover, specifically according to the present invention, as illustrated by FIG. 1, the electronic device 10 for detecting GNSS interference(s) further comprises an interference detection module 30 configured to detect interference when, for Q cycles and on a number U of components of the innovation vector, with Q and U each being an integer greater than or equal to one, the absolute value of the output 28 of the filtering module 26, for at least one filtering applied by said module, is greater than a predetermined threshold.

In other words, such an interference detection module 30 is able to decide that interference has been detected if, for Q consecutive calculation cycles and on a number U of innovation vector components, the absolute value of the filtering output |S^{J}ₙ(k)| is greater than a predetermined threshold, noted Threshold^{J}ₙ hereafter, for the threshold associated with the filter J, and this for one or more of the filters used by the filtering module 26.

In case of effective detection, the interference detection module 30 is suitable for generating and emitting a signal 32 representing the presence of such interference, specifically to alert the user.

As an optional complement, each predetermined threshold depends on the type of filtering applied by the filtering module 26 and/or the current calculation cycle n.

In other words, the Threshold^{J}ₙ associated with the filter J depends on the filtering implemented by this filter J considered (i.e. is specific to the filter J considered) and the calculation cycle n considered and is a predefined value.

More precisely, to predefine such threshold values associated with each respective filter suitable for being used within the filtering module 26, for a given filtering J, for which it is desired for it to detect a given interference, when the application of this given interference is proven (such as in the testing phase or on a computer simulation of the hybridization), the maximum value |S^{J}ₙ(k)|ₘₐₓ obtained by the output |S^{J}ₙ(k)| of the filter J is first determined, and the value Threshold^{J}ₙ of the threshold associated with the filter J is by definition less than the maximum value |S^{J}ₙ(k)|ₘₐₓ obtained by the output |S^{J}ₙ(k)| of the filter J.

Thus, according to the present invention, having defined the type of filtering applied by the filtering module 26, the numbers Q, U and the Threshold^{J}ₙ when the filtering module 26 implements only a single filtering by means of the filter J, it is possible to analyze the interference detection performance by further determining the false alarm probability for the filtering J, with this false alarm probability determined by using the fact that each innovation vector component, in the absence of interference, corresponds to Gaussian white noise, when the calculation cycle varies. The false alarm probability for the filtering J corresponds to the probability that for Q consecutive calculation cycles and on a number U of innovation vector components, |S^{J}ₙ(k)| is greater than the threshold Threshold^{J}ₙ, while there is no interference, and the detection of interference is all the more effective as the false alarm probability is low.

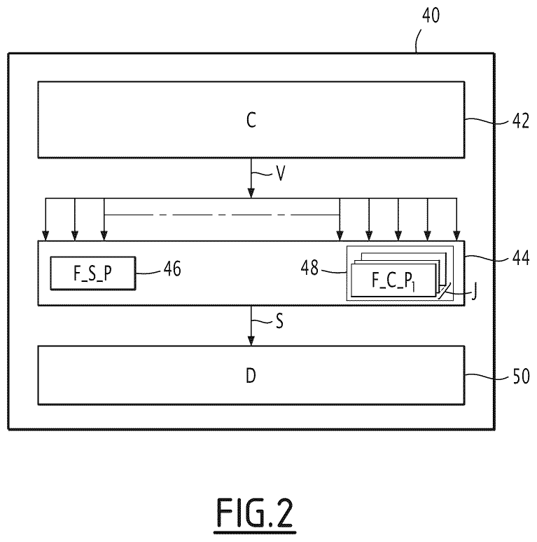

An example of the operation of the electronic device 10 for detecting GNSS interference(s) is described below, in relation to FIG. 2

More precisely, the method 40 for detecting GNSS interference(s) implemented by said electronic device 10 for detecting GNSS interference(s) comprises the steps described below, implemented successively.

According to step 42, as previously indicated, the electronic device 10 for detecting GNSS interference(s) according to the present invention implements a cyclic calculation C of an innovation vector V, implemented by a Kalman filter 20 of said device 10, by hybridization of data provided, as input to said Kalman filter 20, both by an inertial measurement unit 12 suitable for providing navigation measurements 14 and by a GNSS receiver for satellite positioning measurements 18.

Then, according to step 44, as previously indicated, according to the present invention, the electronic device 10 for detecting GNSS interference(s) applies at least one filtering on each component via its filtering module 26, represented by an arrow, of the innovation vector provided at each calculation cycle by said Kalman filter 20. It should be noted that it is possible to apply different filtering on the same component.

It should be noted that, according to two distinct embodiments, two types of possible filtering are suitable for being implemented distinctly during this step 44, as an example.

It should be noted that other types of filtering, known to those skilled in the art, are also suitable for being implemented according to other respective associated embodiments, not represented in FIG. 2 for reasons of simplicity.

According to a first embodiment, the filtering module 26 is configured to apply a weighted sum filtering during a step 46, called F_S_P filtering, on each component (i.e. with each component represented by an arrow in FIG. 2) of the innovation vector provided at each calculation cycle by said Kalman filter 20.

According to a second embodiment, the filtering module 26 is configured to apply, during a step 48, at least one filtering with predetermined filtering coefficients, called F_C_P filtering.

Regardless of the embodiment 46 or 48 of the filtering step 44, the filtering output S is obtained at the end of this step.

Finally, according to step 50, the electronic device 10 for detecting GNSS interference(s) according to the present invention implements, via its detection module, a detection step D of interference when for Q cycles and on a number U of components of the innovation vector, with Q and U each being an integer greater than or equal to one, the absolute value of the filtering output S, for at least one filtering, is greater than a predetermined threshold and this for one or more of the filters used by the filtering module 26.

Each embodiment, 46 and 48 is described more specifically below, in relation to FIGS. 3 to 5.

According to the first embodiment, the filtering module 26 is configured to apply a weighted sum filtering during a step 46, called F_S_P filtering, on each component (i.e. with each component represented by an arrow in FIG. 2) of the innovation vector V provided at each calculation cycle by said Kalman filter 20.

More precisely, according to this embodiment, only a single filtering is performed, so it is not necessary to specify the index of this unique filter for this first embodiment.

Such filtering 46 consists of using a finite impulse response filter whose N filtering coefficients, for each component of the innovation vector V, are suitable for summing the last N normalized input values of said filter, and weighting said resulting sum by a predetermined weighting coefficient.

More precisely, the coefficients of such a filter associated with the F_S_P filtering are suitable for being expressed in the following form

$${a}_{i , n} ( k ) = \frac{1}{{σ}_{n - i} ( k )} ⋆ {M}_{k} ,$$

with Mₖ being any coefficient not depending on the index i (i ranging from 0 to N−1, N being the number of filtering coefficients) and the index n but may depend, as an optional complement, on the index k of said considered component of the innovation vector.

Thus, the filtering output S at cycle n of component k is expressed in the following form:

$${S}_{n} ( k ) = {M}_{k} ( {\sum }_{i = 0}^{N - 1} \frac{{Y}_{n - i} ( k )}{{σ}_{n - i} ( k )} ) = {M}_{k} ( \frac{{Y}_{n} ( k )}{{σ}_{n} ( k )} + \frac{{Y}_{n - 1} ( k )}{{σ}_{n - 1} ( k )} + … + \frac{{Y}_{n - ( N - 1 )} ( k )}{{σ}_{n - ( N - 1 )} ( k )} ) .$$

The filtering thus consists first of performing, for each component k of the innovation vector, at each calculation cycle n, the sum of the last N normalized innovations, a normalized innovation corresponding to the value of the innovation divided by the corresponding standard deviation, and secondly weighting this sum by the coefficient Mₖ.

It should be noted that in the absence of interference, the component Yₙ(k), when n varies, corresponds to Gaussian white noise with a standard deviation sₙ(k), so that the normalized component of the innovation Yₙ(k)/sₙ(k) is also Gaussian white noise with a standard deviation equal to 1, and consequently, the filtering output signal Sₙ(k) is also Gaussian noise with a standard deviation Mₖ*N^{1/2}.

In FIG. 3, view 52 represents, in ordinate the value of the normalized component k Yₙ(k)/sₙ(k) of the innovation vector as a function of the calculation cycle value in abscissa, in the presence of GNSS interference, appearing from the calculation cycle n=900, and view 54 represents, in ordinate the value of the filtering output Sₙ(k) corresponding to the form: weighted sum of this normalized component taking the number N of filtering coefficients such that N=20 and

$${M}_{k} = \frac{1}{\sqrt{N}} .$$

In view 52, before the application of the interference (i.e. before cycle n=900 in abscissa), the normalized innovation corresponds to white noise with a standard deviation of 1, then at the beginning of the application of the interference, between n=900 and n=1000 in abscissa, the normalized innovation has a behavior that does not correspond to white noise, finally after n=1000, the normalized innovation again has a behavior that corresponds to white noise.

It should be noted that the value of the normalized component k Yₙ(k)/sₙ(k) is a dimensionless quantity because it is the component of the innovation divided by the corresponding standard deviation.

This figure also illustrates that in the absence of interference (i.e. before application of the interference) the signal Sₙ(k) is Gaussian noise with a standard deviation of 1, and that under the effect of the interference the maximum reached by the weighted sum, of the order of 8, on view 54 corresponding to the output of the weighted sum filtering, is much greater than the maximum reached by the normalized component worth 3.4 in view 52. Thus, if we consider the case where Q=1 and U=1, which comes down to the fact that the interference is detected if, for one component, the filter output is greater than the threshold on a calculation cycle, we see the interest of using the filter output to detect the interference and not just the normalized component of the innovation.

If we use simply the normalized component of the innovation to detect the interference, as currently done according to the state of the art recalled above, a threshold less than or equal to 3.4 is needed to detect the interference, whereas by using the filter output associated with the F_S_P filtering to detect the interference, in other words with filtering as a weighted sum, a threshold less than or equal to 8 is needed to detect the interference, so that the filter output according to the present invention allows detecting interferences with thresholds significantly higher than with the simple normalized component of the innovation.

In the absence of interference, the filter output as the normalized component being Gaussian noise with a standard deviation of 1, the fact of being able to use a higher detection threshold enables drastically reducing the associated false alarm probability.

According to the example illustrated by FIG. 3, according to the current state of the art, the false alarm probability associated with a threshold of 3.4 would indeed have been equal to 6.7*10-4, which comes down to the fact that Gaussian noise with a standard deviation of 1 has a probability of 6.7*10-4 of exceeding (in absolute value) the value 3.4, whereas the false alarm probability associated with a threshold of 8 obtained according to the present invention is advantageously equal to 1.2*10-15, which comes down to the fact that Gaussian noise with a standard deviation of 1 has a probability of 1.2*10-15 of exceeding (in absolute value) the value 8.

According to the second embodiment preferably used according to the present invention, the filtering module 26 is advantageously configured to apply, during a step 48 of FIG. 2, at least one filtering with predetermined filtering coefficients, called F_C_P filtering. In this example, it is possible to use one or more filters, for example F filters, the j^{th} filter being of index J. Each of the F filters being a finite impulse response filter with N coefficients, of which the equation is expressed in the following form for the filter J of index J:

$${S}_{n}^{J} ( k ) = ( {\sum }_{i = 0}^{N - 1} \frac{{c}_{i}^{J} * {Y}_{n - i} ( k )}{{σ}_{n - i}^{2} ( k )} ) ⋆ {M}_{k , n}^{J} = ( \frac{{c}_{0}^{J} * {Y}_{n} ( k )}{{σ}_{n}^{2} ( k )} + \frac{{c}_{1}^{J} * {Y}_{n - 1} ( k )}{{σ}_{n - 1}^{2} ( k )} + … + \frac{{c}_{N - 1}^{J} * {Y}_{n - ( N - 1 )} ( k )}{{σ}_{n - ( N - 1 )}^{2} ( k )} ) ⋆ {M}_{k , n}^{J}$$

with M^{J}_{k,n} being any coefficient not depending on the index i (i ranging from 0 to N−1, N being the number of filtering coefficients) but may depend on the index k of the considered component of the innovation vector, the index n of the calculation cycle and the index J of the filter considered in the filtering module 26 and (for i between 0 and N−1) the predetermined coefficients The coefficients a^{J}_{i,n}(k) of this filter are therefore expressed in the following form: a^{J}_{i,n}(k)=*M^{J}_{k,n} hence the name of such a filter namely filter with predetermined filtering coefficients.

In the absence of interference, the kth component Yₙ(k) of the innovation vector, when n varies, is Gaussian white noise with a standard deviation sₙ(k), and the output Sₙ(k) of such an F_C_P filtering according to the second embodiment with predetermined filtering coefficients, when n varies, is Gaussian noise with a standard deviation

$${( {\sum }_{i = 0}^{N - 1} \frac{{( {c}_{i}^{J} )}^{2}}{{σ}_{n - i}^{2} ( k )} )}^{+ 1 / 2} * {M}_{k , n}^{J} ,$$

the unit wherein the filtering coefficients cy are expressed being that wherein the innovation is expressed.

As an optional complement, the N coefficients ci of such a filter with predetermined filtering coefficients, for each innovation vector component, are predetermined for each type of interference from a set of predetermined interference types and, for each type of navigation phase from a set of predetermined navigation phase types associated with said vehicle.

Indeed, it is established that, for a given inertial/GNSS hybrid navigation system (i.e. implementing inertial/GNSS hybridization) in a given navigation phase, for a given interference L, on the calculation cycles following the beginning of the interference, the effect due to the interference on the innovation can approximately be written in the form Y=α_{L}*uₙ with uₙ a temporal signal presenting a maximum equal to 1, uₙ varying according to the calculation cycle n considered, and suitable for depending on the considered navigation phase while not depending on the considered component in the innovation vector, nor on the considered interference but just on its type.

Typically, if we consider the type of interference where the error on the radio frequency signals causes the appearance of an error on the calculated position increasing linearly over time, uₙ will not depend on the slope giving the increase, as a function of time, of the error on the calculated position.

α_{L}, for its part, is a coefficient that depends on the considered component in the innovation vector and the considered interference (the value of the errors applied on the radio frequency signals), without depending on the considered navigation phase nor the calculation cycle n. For example, in the case of the interference type where the error on the radio frequency signals causes the appearance of an error on the calculated position increasing linearly over time, α_{L} depends on the slope giving the increase (as a function of time) of the error on the calculated position.

According to this optional complement, a first list of possible types of interferences is established comprising for example a type of interference consisting of the appearance of a fixed error on the calculated position, another type of interference consisting of the appearance of an error increasing linearly over time on the calculated position, etc.

Moreover, a second list of the different navigation phases of the carrier using GNSS data and inertial data is also established.

From these two lists, for each type of interference and each navigation phase, predetermined filtering coefficients cy are determined from the evolution obtained on a component of the innovation vector just after applying the interference of the considered type, when the carrier is in the considered navigation phase.

In this case, the application of the interference of the considered type is indeed proven and the filtering coefficients ci are suitable for being determined either in the testing phase or on a computer simulation of the hybridization implemented by the Kalman filter 20, considering that, advantageously, for each considered navigation phase, there are as many filters as there are considered types of interferences. In other words, advantageously according to the present invention, the predetermined filtering coefficients are optimized according to the interference type and/or the type of navigation phase, and thus suitable for differing according to the interference type and/or according to the type of navigation phase.

More precisely, for the same type of navigation phase, two distinct types of interference are suitable for being associated with distinct sets of filtering coefficients. Similarly, for the same interference type, two distinct types of navigation phases are suitable for being associated with distinct sets of filtering coefficients.

Indeed, for a given navigation phase, the filtering coefficients CN are suitable for being predetermined, for example, for each possible type of interference, by designating, for example, J the interference of the considered type, first by applying this interference J on an inertial/GNSS hybridization at calculation cycle n1, then by selecting a component k₀ of the innovation vector by recording the successive N values Yₙ₁(k₀), Yₙ₁₊₁ (k₀), . . . , Y_{n1+N-1}(k₀) of the component k₀, so that:

$${c}_{0}^{J} = {Y}_{n 1 + N - 1} ( {k}_{0} ) , {c}_{1}^{J} = {Y}_{n 1 + N - 2} ( {k}_{0} ) , … , {c}_{N - 1}^{J} = {Y}_{n 1} ( {k}_{0} ) .$$

Such coefficients associated with said given navigation phase are then used, when the carrier (i.e. the vehicle) is in said given navigation phase, and this considering all possible types of interference, to define, for each component k of the innovation vector, the coefficients a^{J}_{i,n}(k) of the filter J according to the formula

$${a}_{i , n}^{J} ( k ) = \frac{{c}_{i}^{J}}{{σ}_{n - i}^{2} ( k )} ⋆ {M}_{k , n}^{J} ,$$

filter which will be applied on the component k of the innovation vector and which will contribute, via its output S, to the subsequent detection of the presence or absence of this type of interference J. Thus, according to this second embodiment, for each component of the innovation vector, there are as many filters as there are considered types of interferences.

Such a second embodiment 48 based on the use of at least one filtering with predetermined filtering coefficients, called F_C_P filtering, has the advantage that, for each considered navigation phase and each considered type of interference, the method of calculating the predetermined coefficients cpJ is extracted from the method that itself defines a filter, which, when the carrier is in the considered navigation phase and for the considered type of interference, allows for a given false alarm probability (the false alarm probability being the probability of detecting interference when there is none) to obtain the minimum probability of non-detection (the probability of non-detection being the probability of not detecting this type of interference when it is present).

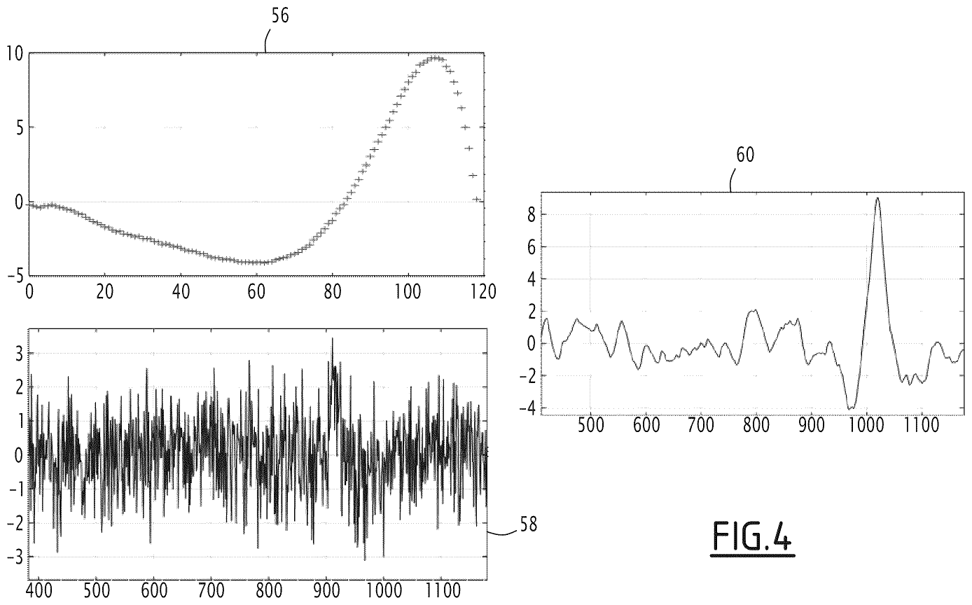

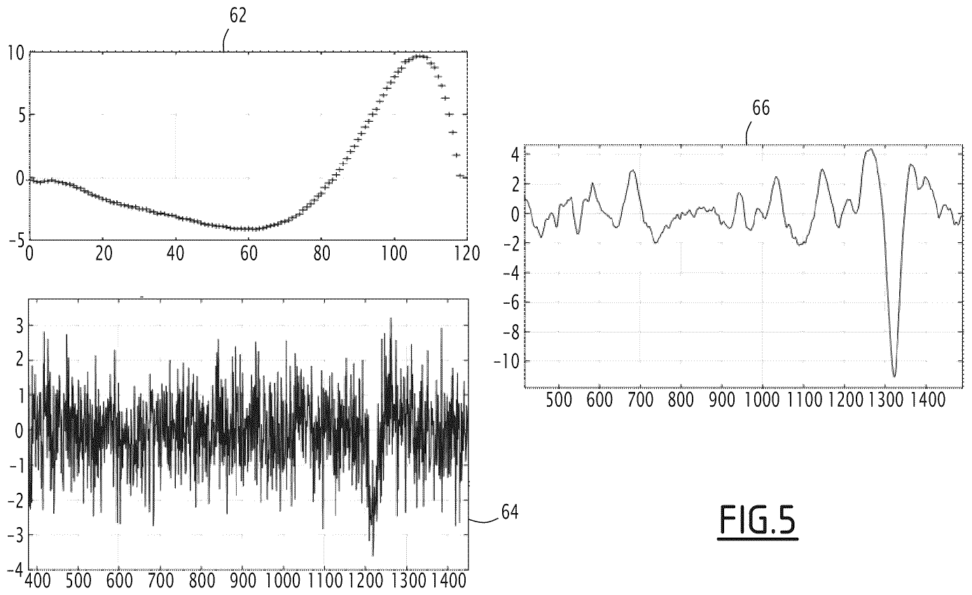

FIGS. 4 and 5 are associated with such a preferred second embodiment 48 according to the present invention considering, for simplicity, a single filter J with predetermined filtering coefficients, FIG. 4 representing the effect of interference appearing from the calculation cycle n=900, while FIG. 5 represents the effect of interference appearing from the calculation cycle n=1200.

In FIG. 4 view 58 represents, again as in view 52 of FIG. 3, in ordinate the value of the normalized component k Yₙ(k)/σₙ(k) of the innovation vector as a function of the calculation cycle value in abscissa, in the presence of GNSS interference, (already illustrated by FIG. 3) appearing from the calculation cycle n=900.

View 60 of FIG. 4 represents, in the presence of GNSS interference, appearing from the calculation cycle n=900, in ordinate the value of the filtering output Sun (k) of the filter J with predetermined filtering coefficients (the coefficients cy used for this filter are illustrated by view 56 of FIG. 4) and:

$${M}_{k , n}^{J} = {( \frac{{c}_{0}^{J 2}}{{σ}_{n}^{2} ( k )} + \frac{{c}_{1}^{J 2}}{{σ}_{n - 1}^{2} ( k )} + … + \frac{{c}_{N - 1}^{J 2}}{{σ}_{n - ( N - 1 )}^{2} ( k )} )}^{- 1 / 2}$$

such that in the absence of interference, the filter output is Gaussian noise with a standard deviation of 1.

In FIGS. 4 and 5, the same filter J with predetermined filtering coefficients is applied, so that views 56 of FIG. 4 then 62 of FIG. 5, representing the coefficients cy of this filter J as a function of the index i in abscissa, are identical.

In FIG. 5 view 64 represents in ordinate the value of the normalized component k Yₙ(k)/σₙ(k) of the innovation vector as a function of the calculation cycle value in abscissa, in the presence of GNSS interference, appearing from the calculation cycle n=1200.

View 66 of FIG. 5 represents, in the presence of GNSS interference, appearing from the calculation cycle n=1200, in ordinate the value of the filtering output Sun (k) of the filter J with predetermined filtering coefficients illustrated by view 56 of FIG. 4 and

$${M}_{k , n}^{J} = {( \frac{{c}_{0}^{J 2}}{{σ}_{n}^{2} ( k )} + \frac{{c}_{1}^{J 2}}{{σ}_{n - 1}^{2} ( k )} + … + \frac{{c}_{N - 1}^{J 2}}{{σ}_{n - ( N - 1 )}^{2} ( k )} )}^{- 1 / 2}$$

such that, in the absence of interference, the filter output is Gaussian noise with a standard deviation of 1.

In both cases illustrated by FIGS. 4 and 5 associated with distinct interference appearance cycles n=900 and n=1200, it is first noted that, in the absence of interference, the filtering output as the normalized component are Gaussian noises with a standard deviation of 1. Moreover, it is noted that the maximum, of the order of 9 on FIGS. 4 and 11 on FIG. 5, reached by the output, in absolute value, of the filtering implemented specifically according to the present invention, on views 60 of FIG. 4 as 66 of FIG. 5, under the effect of the interference is significantly greater than the maximum, of the order of 3.4 on FIG. 4 and 3.5 on FIG. 5, reached by the normalized component of the innovation, in absolute value, on views 58 of FIG. 4 and 64 of FIG. 5.

Thus, we see the interest of using the filter output of the filtering module 26 to detect the interference and not just the normalized component of the innovation as proposed according to the current state of the art.

Indeed, by using the filter output, we can therefore detect interferences with thresholds significantly higher than the simple normalized component of the innovation which advantageously enables reducing the associated false alarm probability.

Those skilled in the art will understand that the invention is not limited to the described embodiments, nor to the particular examples of the description, the embodiments and variants mentioned above being suitable for being combined with each other to generate new embodiments of the invention.

The present invention thus proposes a particular architecture of an electronic device for detecting GNSS interference(s) using the components of the innovation vector not directly, but using the output of a filtering of these components, advantageously optimized according to the interference type and/or type of navigation phase, which enables exploiting the fact that the evolution over time of the components of the innovation vector is different depending on whether interference of GNSS data is present or not. The filtering 44 used indeed enables highlighting this difference in evolution over time, at the level of the output returned by the filtering.

1. An electronic device comprising:
an inertial measurement unit providing navigation, measurements;
a GNSS receiver measuring satellite position;
a Kalman filter cyclically calculating an innovation vector by hybridization of data provided, as input to the Kalman filter, by said inertial measurement unit and by said GNSS, receiver;
a filter processor applying at least one finite impulse response filter to each component of the innovation vector provided at each calculation cycle by said Kalman filter, wherein the filter coefficients are determined for each type of interference from a set of predetermined types of interferences and for each type of navigation phase from a set of predetermined types of navigation phases associated with a vehicle; and
an interference detection module detecting interference when for Q cycles and on a number U of components of the innovation vector, Q and U each being an integer greater than or equal to one, the absolute value of the output of said filter processor, for at least one filter applied by said filter processor, is greater than a predetermined threshold.

2. The device according to claim 1, wherein said predetermined threshold depends on the type of filtering applied by said filter processor and/or the current calculation cycle.

3. A vehicle comprising an electronic device according to claim 1.

4. A method for detecting GNSS interference(s), implemented by an electronic device, comprising:
cyclic calculation of an innovation vector, by a Kalman filter of the device, by hybridization of data provided, as input to the Kalman filter, by an inertial measurement unit providing navigation measurements and by a GNSS receiver measuring satellite position;
application of at least one filter on each component of the innovation vector provided at each calculation cycle by the Kalman filter, using a finite impulse response filter, whose filter coefficients are determined for each type of interference from a set of predetermined types of interferences and for each type of navigation phase from a set of predetermined types of navigation phases associated with the vehicle; and
detection of interference when, for Q cycles and on a number U of components of the innovation vector, with Q and U each being an integer greater than or equal to one, the absolute value of the filter output, for at least one filter, is greater than a predetermined threshold.

5. A non-transitory computer-readable medium storing instructions which, when executed by a computer, cause the computer to implement the method according to claim 4.
